(19) United States
(12) Patent Application Publication
(10) Pub. No.: US 2008/0048819 A1
(43) Pub. Date: Feb. 28, 2008

(54) Modular Fuseholders With Wireless Communication Capabilities

(75) Inventor: Matthew R. Darr, Godfrey, IL (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 11/925,519

(22) Filed: Oct. 26, 2007

Related U.S. Application Data
(63) Continuation-in-part of application No. 11/122,945, filed on May 5, 2005.

(51) Int. Cl. H01H 85/30; G08B 21/00

(52) U.S. Cl. 337/206; 340/638

(57) ABSTRACT

Modular fuseholders and systems are provided. Modular fuseholders include a main body having a fuse-receiving receptacle for substantially enclosing a fuse within, a detecting means connected to the fuse, and a signal transmitting means connected to the detecting means. The detecting means is configured to detect an operational state of the fuse, and the signal transmitting means is configured to transmit a wireless signal to a remote device for indicating the an operational state of the fuse. Modular fuseholder systems include a modular fuseholder housing a fuse.

### CROSS REFERENCE TO RELATED APPLICATIONS

This application is a continuation-in-part application of U.S. application Ser. No. 11/122,945 filed May 5, 2005, titled “Modular Indicating Fuse Holder,” the disclosure of which is hereby incorporated herein by reference in its entirety.

### BACKGROUND OF THE INVENTION

The application relates generally to modular fuseholders, and, more particularly, to modular fuseholders adapted for wireless fuse state indication.

Fuses are widely used as overcurrent protection devices to prevent costly damage to electrical circuits. Fuse terminals typically form an electrical connection between an electrical power source and an electrical component or a combination of components arranged in an electrical circuit. A fusible link is connected between the fuse terminals, so that when electrical current flowing through the fuse exceeds a predetermined limit, the fusible link melts and opens the circuit through the fuse to prevent electrical component damage.

Fuse indicators have been developed for various types of fuses to facilitate identification of inoperable fuses due to an opened fuse link. Fuses including such indicators, sometimes referred to as indicating fuses, typically include a high resistance secondary fuse link and an indicator element extending on or visible through a portion of the outer surface of an insulative fuse body. The secondary fuse link extends between conductive end caps or terminals that are attached to either end of the fuse body, and the secondary fuse link establishes a conductive path in parallel with the primary fuse link. When the primary fuse link operates to open the electrical circuit therethrough, current flows through the secondary fuse link, which causes the indicator element to visibly indicate the operational state of the fuse. However, an operator or appropriate personnel must be in the physical area or proximity of the fuse to visibly identify the state of the fuse. By visually observing the indicating elements of the fuses, and without removing any of the fuses from the system, personnel may quickly identify opened (or operated) fuses and replace opened fuses to restore circuitry affected thereby. Indicating fuses are commercially available from, for example, Cooper Bussmann of St. Louis, Mo., and have proven effective when used with open fuse blocks or fuse holders wherein the indicating fuses are visible.

Conventionally, some modular fuse holders enclose one or more fuses in a fuse holder body, and such fuse holders include a slidably or rotatably mounted drawer mechanism to engage fuses to fuse clips in the body of the fuse holder when the drawer is closed, and to pull the fuses from the fuse clips when the drawer is opened. Because the fuses are enclosed in the fuse holder, the body of the fuse is concealed within the fuse holder, requiring that the drawer must be opened and each fuse removed from the fuse holder for inspection, regardless of whether indicating or non-indicating fuses are employed.

Some manufacturers, including Cooper Bussmann, also provide wireless communication fuse state indicator systems. In such systems, a wireless communication and/or sensor component is either integrated within the body of fuse or is provided via an external module that attaches to the body of the fuse. Neither of such configurations is ideal for modular fuseholders.

### SUMMARY OF THE INVENTION

The present invention satisfies the above-described need by providing a modular fuseholder having a main body including a fuse-receiving receptacle configured to substantially enclose a fuse within, a detecting means connected to the fuse, and a signal transmitting means connected to the detecting means. The detecting means is configured to detect at least one operational state of the fuse, and the signal transmitting means is configured to transmit a wireless signal to a remote device for indicating the at least one operational state of the fuse. In some embodiments, the detecting means may be a monitoring circuit, such as a sensor that measure current, voltage, or temperature. In some embodiments, the signal transmitting means may be a communication device configured to transmit a radio frequency signal, and may be a transponder, a transmitter, or a responder. Modular fuseholder systems are also provided, wherein a fuse is enclosed within a modular fuseholder of the present invention.

Generally, the modular fuseholders and systems of the present invention may also include a pivotally mounted drawer coupled to the outer surface of the main body of the modular fuseholder. In some embodiments, the fuse-receiving receptacle of the modular fuseholder is configured to receive a cylindrical fuse. In certain embodiments, the signal transmitting means may partially be positioned within the drawer, while in other embodiments, the signal transmitting means may be positioned within the main body. In some embodiments, the signal transmitting means may be powered by a battery, and/or further include a processor and/or memory. The modular fuseholders may also include optical isolators that latch when a fuse element of the fuse opens and breaks an electrical connection through the fuse, thereby enabling the signal transmitting means to transmit a wireless signal to a remote device. In some embodiments, an indicating assembly configured to provide visual indication of the operative state of the fuse when the fuse is received in fuse-receiving receptacle may also be included in the modular fuseholder. For instance, the indicating assembly may include an indicating element that changes appearance when a fuse element of the fuse opens and breaks an electrical connection through the fuse.

These and other aspects, features and embodiments of the present invention will become apparent to those skilled in the art upon consideration of the following detailed description of illustrated embodiments exemplifying the best mode for carrying out the invention as presently perceived.

### BRIEF DESCRIPTION OF THE DRAWINGS

FIG. 1 is a schematic view of an exemplary fuse.

FIG. 2 is a perspective view of a plurality of exemplary modular fuse holders which may be used with the fuse shown in FIG. 1.

FIG. 3 is a front view of a first embodiment of the fuse holder shown in FIG. 2 with an indicating fuse in the fuse holder.

FIG. 4 is a front view of a second embodiment of the fuse holder shown in FIG. 2.

FIG. 5A is a perspective view of a modular fuseholder in accordance with an exemplary embodiment of the present invention.

FIG. 5B is a side cross-sectional view of the modular fuseholder of FIG. 5A, illustrating internal components and construction thereof.

FIG. 5C is a perspective view of the modular fuseholder of FIG. 5A, with the drawer and a portion of the outer surface removed, illustrating internal components and construction thereof.

FIG. 6A is a side cross-sectional view of modular fuseholder in accordance with an alternative embodiment of the present invention, illustrating internal components and construction thereof.

FIG. 6B is a perspective view of the modular fuseholder of FIG. 6A with a portion of the outer surface removed, illustrating internal components and construction thereof.

The appended drawings illustrate certain exemplary embodiments of the present invention and are therefore not to be considered limiting of its scope, as the invention may admit to other equally effective embodiments.

### DETAILED DESCRIPTION OF THE INVENTION

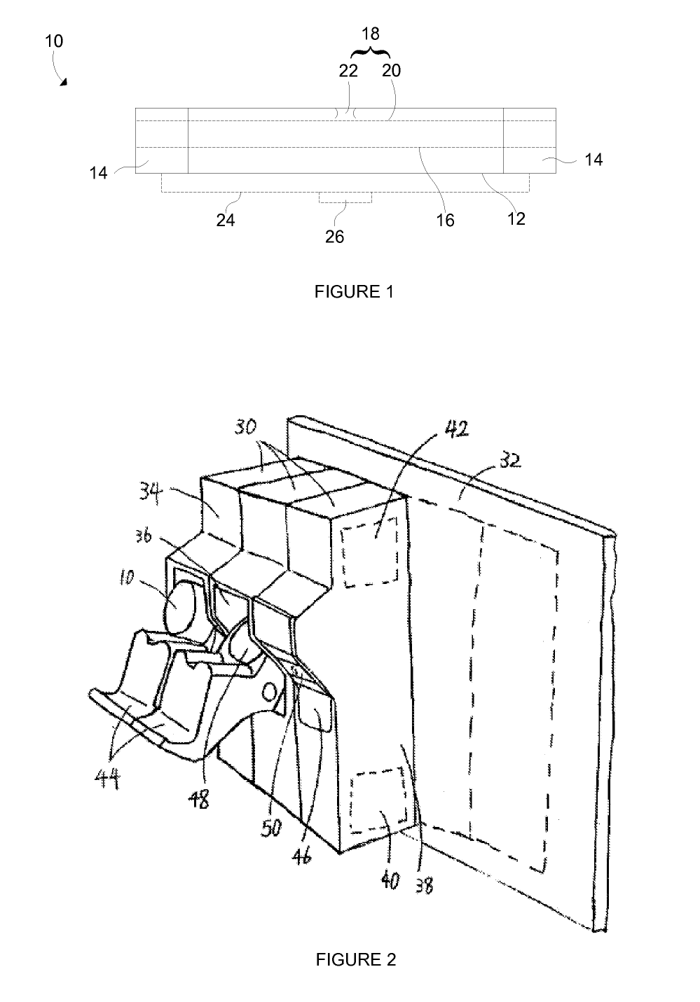

FIG. 1 is a schematic illustration of an exemplary fuse 10 applicable to the present invention. Fuse 10 is a cylindrical cartridge fuse, and includes an insulative (i.e., nonconductive) fuse body 12, two conductive end caps or terminal elements 14 attached to fuse body 12 on either end thereof, and a primary fuse link 16 extending between conductive terminal elements 14.

In an exemplary embodiment, the fuse body 12 is elongated and is generally cylindrical. The terminal elements 14 define a line side terminal element and a load side terminal element on either end of the body 12, and in the illustrated embodiment are generally cap shaped and complementary in shape to fuse body 12. It is appreciated, however, that other shapes and configurations of the fuse body 12 and terminal elements 14 may be provided in alternative embodiments. Therefore, the embodiments of the fuse shown and described herein are for illustrative purposes only, and the invention is not intended to be restricted to a particular fuse type, class, or rating.

A primary fuse link 16 extends between and electrically connects to terminal elements 14, and when terminal elements 14 are connected to line-side and load-side electrical circuitry (not shown), a primary current path is created through primary fuse link 16 between terminal elements 14. Primary fuse link 16 is a known fuse element or assembly, and in an exemplary embodiment includes one or more weak spots or areas of reduced cross sectional area (not shown) therein. Primary fuse link 16 is constructed to withstand only certain electrical currents flowing therethrough. Upon an occurrence of a predetermined magnitude of current corresponding to the current rating of fuse 10, sometimes referred to as an overcurrent condition, the primary fuse link 16 melts, vaporizes, disintegrates, or otherwise fails, thereby breaking the electrical connection through primary fuse link 16.

In an indicating fuse, and as shown in FIG. 1, fuse 10 further includes a known fuse state indicator 18 integrally formed with fuse body 12. Fuse state indicator 18 includes a secondary fuse link 20 extending between and electrically connected to terminal elements 14, and an indicating lens 22 coupled to the body 12 in proximity to the secondary fuse link 20. The secondary fuse link 20 creates a second current path through in parallel with the primary current path of the primary fuse link 16. The secondary fuse link 20 has a much higher electrical resistance than primary fuse link 16, however, so that during normal operation of fuse 10, substantially all of the current passing through the fuse 10 passes through the primary fuse link 16. When the primary fuse link 16 opens and interrupts the current path therethrough, current is diverted into the secondary fuse link 20 until the secondary fuse link 16 also opens to interrupt the current therethrough. Indicating element 18 is positioned adjacent the lens 22 and may be activated to visually indicate the state of fuse 10. For example, transparent indicating lens 22 is positioned proximate the conductive material of secondary fuse link 20, and the appearance change, such as a color change that is visible through indicating lens 22, provides local fuse state indication. In certain embodiments, when current flows through the secondary fuse link 20, the indicating element 18 may present a visibly different external appearance of fuse 10 in the vicinity of fuse state indicator 18. In other embodiments, as the secondary fuse link 20 opens in an overcurrent condition, the indicating element 18 may be activated to indicate the state of fuse 10 as operable or inoperable via a physical transformation of the fuse state indicator 18. In some embodiments, the indicating element 18 may present a certain external appearance when the fuse 10 is operable, a second visibly different external appearance when the current flows through the secondary fuse link 20, and third visibly different external appearance when the fuse 10 is inoperable. A variety of indicating elements and mechanisms are known in the art and could be employed in the fuse 10, and the invention is not intended to be restricted to any particular indicating element or mechanism for local fuse state indication.

In a non-indicating fuse (i.e., a fuse not having the integral indicator 18), and also as illustrated in FIG. 1, a known external fuse state indicator 24 may be employed to nonetheless indicate an operating state of the fuse 10. The fuse state indicator 24 is separately provided from the fuse 10, and is externally coupled to and electrically connected with one or both of terminal elements 14 in use. The fuse state indicator 24 includes an indicating element 26 such as a lamp, and operates in a similar manner to the integral indicator described above. When the primary fuse link 16 opens, externally mounted indicator 24 changes in visual appearance, such as via illumination of lamp 26, to provide local fuse state indication. It is appreciated, however, that a variety of indicating elements for indicting fuses, including those employing wireless communications capabilities, are known and may be employed as externally mounted indicator 24 in lieu of a lamp.

FIG. 2 is a perspective view of a plurality of exemplary modular fuse holders 30 according to the present invention with fuse 10 shown in FIG. 1. Fuse holders 30 are modular, and may be arranged in a side-by-side configuration on a panel 32 to accommodate as many fuses as desired in an electrical system. In an exemplary embodiment, each modular fuse holder 30 receives a single cylindrical cartridge fuse 10 therein, although it is appreciated that each fuse holder 30 may receive more than one fuse 10 in alternative embodiments. It is also appreciated that the fuse holders 30 may also receive non-cylindrical fuses in alternative embodiments, including but not limited to rectangular fuses.

Each fuse holder 30 includes a main body 34 and a receptacle 36 defined in main body 34. Each receptacle 36 is configured to receive a fuse 10 therein, and main body 34 includes an outer surface 38 substantially enclosing fuse 10 located in receptacle 36. Main body 34 further includes a line side terminal 40 (shown in phantom in FIG. 2) and a load side terminal 42 (also shown in phantom in FIG. 2) positioned within each receptacle 36. Line and load side terminals 40, 42 are, for example, known fuse clips configured to engage the terminal elements 14 (FIG. 1) of the fuse 10, although it is appreciated that a variety of terminal elements known in the art may be employed in lieu of fuse clips in alternative embodiments. The line side terminal 40 is connected to a power source or power supply (not shown), and the load side terminal 42 is connected to a power-receiving device or component (not shown) in the electrical system. When the line and load side terminals 40, 42 are mechanically and electrically engaged with conductive terminal elements 14 (shown in FIG. 1) of fuse 10, the fuse 10 provides overcurrent protection for the power-receiving devices in the electrical system and isolates the power-receiving devices from damaging overcurrent events.

In one embodiment, each main body 34 further includes a drawer 44 pivotally mounted thereto. Drawer 44 is pivotable between an open position (shown with two fuseholders in FIG. 2) and a closed position (shown with one fuseholder in FIG. 2) described below. The drawer 44 is configured to receive the fuse 10 and to engage line and load side terminals 40, 42 with terminal elements 14 (shown in FIG. 1) of fuse 10 mounted thereon when in the closed position, or alternatively to pull the terminal elements 14 of the fuse 10 from the line and load-side terminals 40, 42 when in the opened position. The drawer 44 further includes a front face 46, a slot 48 for mounting a fuse 10 thereon, and a fuse state indication aperture 50 defined in and extending through the front face 46 of the drawer 44. The fuse state aperture 50 is in communication with receptacle 36, and is configured to visibly expose either an indicating fuse or a non-indicating fuse having an externally mounted indicator to provide local fuse state indication (described in detail hereinafter).

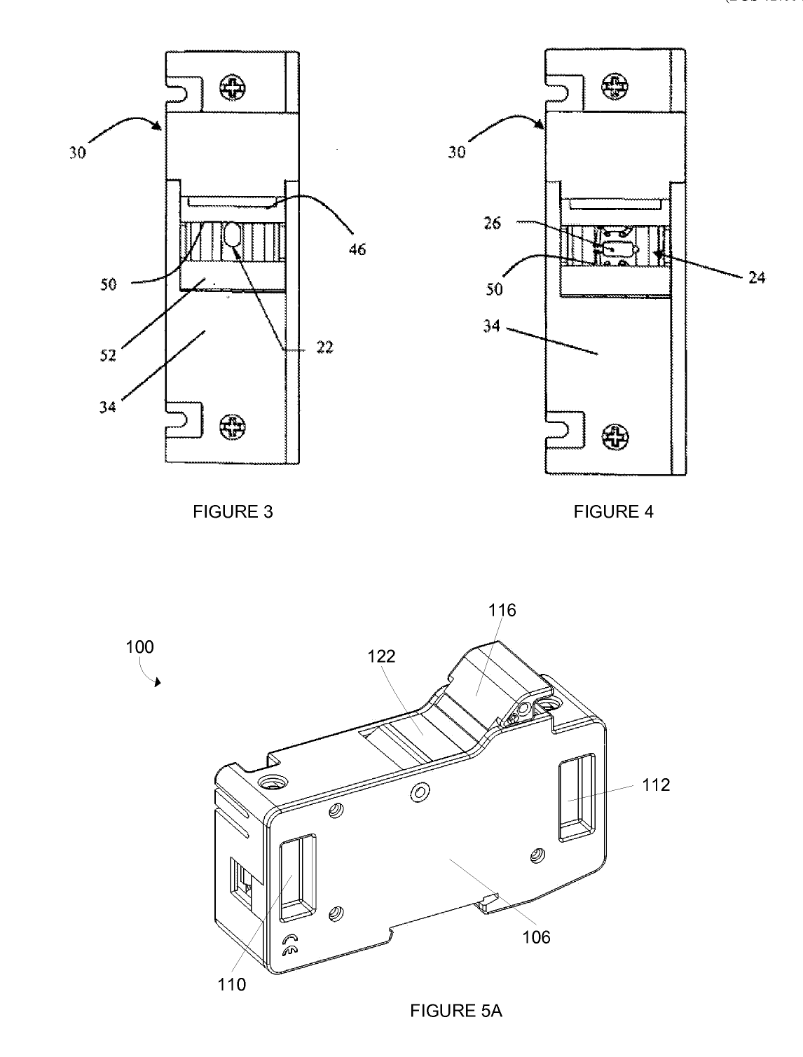

FIG. 3 is a front view of fuse holder 30 shown in FIG. 2 with an indicating fuse 10 in the fuse holder 30 and the drawer 44 in the closed position. A transparent window 52 is attached to front face 46 and covers the fuse state aperture 50. The window 52 blocks dust and contaminants from entering into the interior of the fuse holder 30. The indicating fuse 10 is received in the main body 34, and indicating the lens 22 of the indicating fuse 10 is positioned at a location corresponding to fuse state aperture 50 of the fuse holder 30. Thus, the indicating lens 22 is exposed and visible through fuse state aperture 50, and indicates an operative state of the indicating fuse 10.

FIG. 4 is a front view of another embodiment of the fuse holder 30 with a non-indicating fuse 10 and an externally mounted indicator 24 in fuse holder 30. Indicator 24 is externally coupled to the non-indicating fuse 10 for providing fuse state indication, and both of indicator 24 and the non-indicating fuse 10 are received in main body 34. The indicating element 26 of the external indicator 24 is then positioned at a location corresponding to fuse state aperture 50. Thus, the indicating element 26 is exposed and visible through fuse state aperture 50, and provides fuse state indication via visual observation of main body 34.

With the fuse state aperture 50 formed in the body 34 of the fuse holder 30, the modular fuse holder 30 can provide local fuse state indication both with indicating fuses and the non-indicating fuses utilizing the external mounted indicator 24. Thus, a single fuse holder 30 body 34 including the fuse state aperture 50 allows universal use of the fuse holder 30 with indicating fuses and non-indicating fuses to provide local fuse state identification, and the fuse holder 30 provides a low cost indication system which conventional modular fuse holders cannot accommodate.

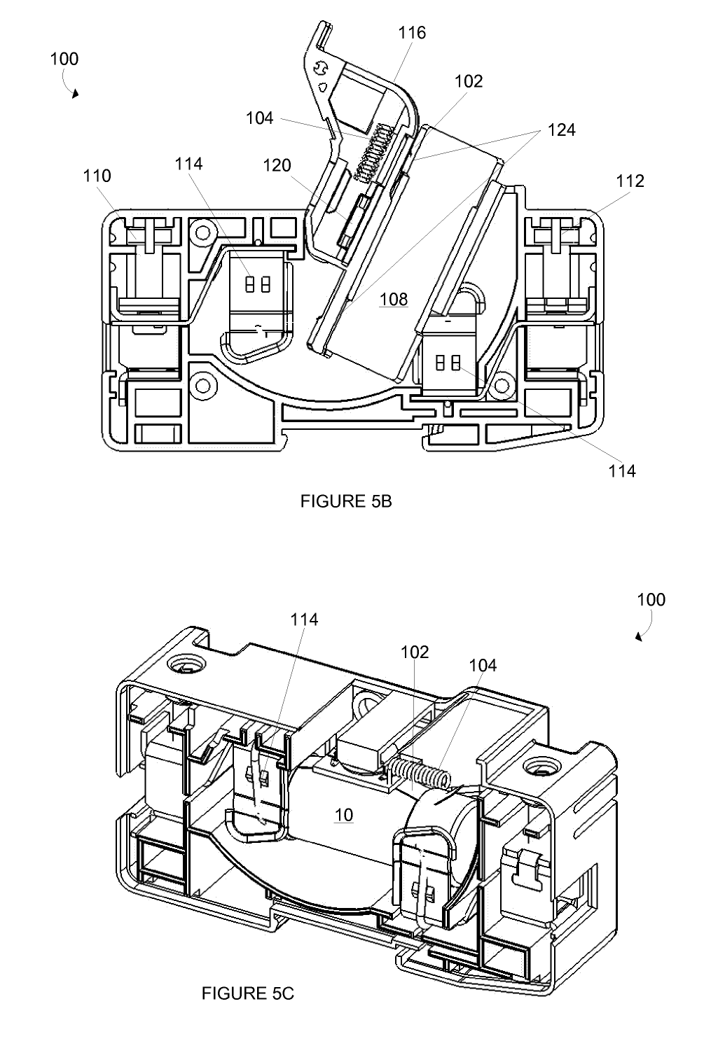

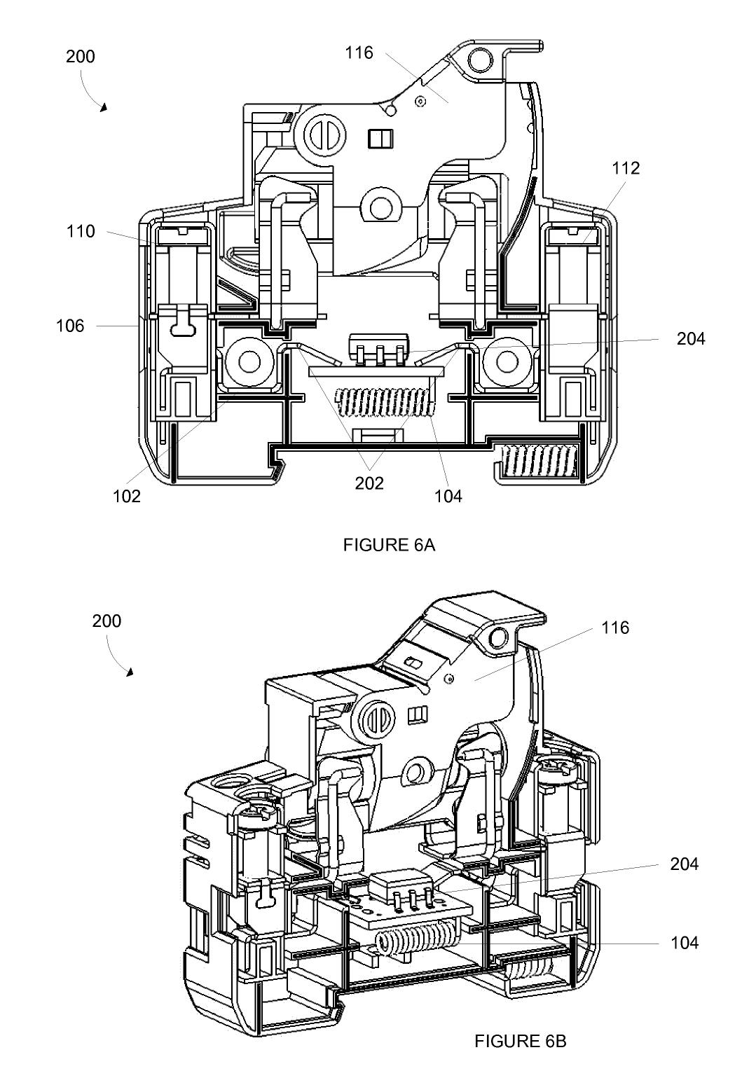

In accordance with yet other embodiments, some of which are shown and described with respect to FIGS. 5 and 6, a modular fuse holder 100 may be configured with wireless communication capability for communicating to a remote device at least one operational state of a fuse 10 that is loaded into the fuse holder 100. In such embodiments, the modular fuse holder 100 houses a monitoring circuit or sensor 102, a wireless communication device 104 and any other related components for detecting and communicating at least one operational state of a fuse 10. In such embodiments, indicating and non-indicating fuses 10 may be loaded into the fuse holder 100 and the fuse state indication aperture 50 and/or window 52 (as described with respect to FIGS. 2-4) may or may not be included.

As shown in FIGS. 5A-5C, a modular indicating fuse holder 100 according to certain exemplary embodiments of the present invention includes a main body 106 having a fuse-receiving receptacle 108 therein. The receptacle 108 is configured to receive a fuse 10. In certain embodiments, a fuse 10 received within the receptacle 108 may be substantially enclosed within the main body 106. In other embodiments, the receptacle 108 may be configured such that the fuse 10 is partially enclosed within the main body 106 or mounted externally to the main body 106.

The main body 106 includes a line side terminal 110 and a load side terminal 112. The line side terminal 110 and load side terminal 112 may each be connected to fuse clips 114 or other connection points configured to engage the conductive terminal elements of the fuse 10 when the fuse 10 is installed within the receptacle 108. Accordingly, the fuse clips 114 or other connection points are preferably positioned with the fuse-receiving receptacle 108. The line side terminal 110 is connected to a power source or power supply (not shown), and the load side terminal 112 is connected to a power-receiving device or component (not shown) in the electrical system. When the line side terminal 110 and load side terminal 112 are electrically connected to the terminal elements of the fuse 10, via the fuse clips 114 or other connection points, the fuse 10 provides overcurrent protection for the power-receiving devices in the electrical system and isolates the power-receiving devices from damaging overcurrent events.

The main body 106 includes a drawer 116 pivotally mounted thereto. The drawer 116 is pivotable between an open position (shown in FIG. 5B) and a closed position (shown in FIG. 5A). The drawer 116 is configured to receive a fuse 10 and, when placed in the closed position, to engage the terminal elements of fuse 10 with the fuse clips 114. Conversely, when the drawer 116 is placed in the open position, it will disengage the terminal elements of the fuse 10 from the fuse clips 114.

Those skilled in the art will appreciate that, in certain embodiments, a fuse holder may incorporate a slidable drawer, rather than the pivotable drawer 116, for introducing the fuse 10 into the receptacle 108. In still other embodiments, the fuse holder may incorporate a door or removable panel for allowing access to the receiving receptacle 108, as opposed to a drawer mechanism. In other embodiments, the receptacle 108 may be configured as a socket (including connection points coupled to the line side terminal 110 and the load side terminal 112) and the terminal elements of the fuse 10 may be configured as a plug for mating with the socket. Other configurations for the fuse holder 100 and its fuse-receiving receptacle 108 will also be apparent to those of ordinary skill in the art and are considered to be within the scope of the present invention.

The fuse holder 100 is modular, in that it may be arranged on a panel or within an electrical device in a side-by-side configuration with other fuse holders 100, so as to accommodate as many fuses 10 as desired in an electrical system. The fuse holder 100 shown in FIGS. 5A-5C is designed to receive a single cylindrical cartridge fuse 10. However, in other embodiments the fuse holder 100 may designed to receive more than one fuse 10. In some embodiments, the fuse holder 100 may be designed to receive non-cylindrical fuses, including but not limited to rectangular fuses.

The fuse holder 100 also includes an wireless communication device 104 for communicating, via a wireless link, with a remote device (not shown). The wireless communication device 104 may include a processor, a memory, and/or an antenna. The wireless communication device 104 may be configured to indicate whether the fuse 10 is in an operational state (i.e., a current carrying or unopened condition completing an electrical connection through the fuse), or whether the fuse 10 is in a non-operational state (i.e., an opened condition breaking the electrical connection through the fuse). In some embodiments, when the primary fuse link 16 opens, the entire fault current would be directed to the circuitry of the wireless communication device 104. If the circuitry of the wireless communication device 104 is selected so that the fault current destroys or renders it inoperable, the wireless communication device 104 would no longer be able to send a wireless signal. Additionally, when the primary fuse link 16 opens, heat and electrical arcing associated with the opening may damage the wireless communication device 104 and render it inoperable such that the wireless communication device 104 would no longer be able to send a wireless signal. Therefore, a remote device can be programmed to presume that the lack of a signal from the wireless communication device 104 means that the associated fuse 10 is in a non-operational state.

The circuitry of the wireless communication device 104 may include two contact points 124, which are positioned in the fuse-receiving receptacle 108 so as to make electrical contact with the respective terminal elements 14 of the fuse 10 and thereby electrically connect in parallel with the primary fuse link 16 of the fuse 10. In some embodiments, the wireless communication device 104 may be located within the main body 106 or drawer 116 of the fuse holder 100, although it is understood that in alternative embodiments, the wireless communication device 104 may be exterior to the main body 106 of the modular fuse holder 100.

In some embodiments, the wireless communication device 104 may be integrated with or otherwise logically connected to a sensor 102. The sensor 102 may include components for determining at least one operational state of a fuse 10. The sensor 102 may have contact points 124 for connecting to fuse 10 or may be in proximity to fuse 10. The sensor 102 may thus collect information regarding the fuse 10 and communicate such information to a remote device via the wireless communication device 104. In certain embodiments, the sensor 102 may be configured in parallel across the terminal elements 14 of fuse 10, and may monitor the voltage differential across the fuse 10 terminal elements 14. The sensor 102 may be powered by a battery 120 (shown in FIG. 5B), or access power via wiring (not shown) into the device.

The wireless communication device 104 may communicate via any suitable wireless technology and/or protocol, such as radio frequency (RF), Bluetooth, infrared, ultra-wideband, cellular, etc. For example, in some embodiments, the wireless communication device 104 may be a wireless RF transmitter or an RF identification (RFID) tag or transponder, and may communicate wirelessly with a remote device over a predetermined RF carrier wave such as, for example, 100-500 kHz, or in some embodiments, about 904 MHz. Other frequency carriers may be employed and will also be apparent to those of ordinary skill in the art and are considered to be within the scope of the present invention. One of skill in the art will recognize that increasing the frequency of the carrier wave will increase the data transmission rate between the wireless communication device 104 and the remote device.

In certain embodiments, when employing the use of an RFID tag, the operating range or distance of communication between the wireless communication device 104 and a remote device is determined, in part, by the power supply. In some embodiments, the wireless communication device 104 may be a passive RF transmitter, where the wireless communication device 104 does not store data relating to the operational state of the fuse 10, but relies on a carrier wave generated by a remote device for power to transmit and respond to the device. In such embodiments, the operating range of communication may range from a few centimeters to a few meters, depending on factors such as the frequency of the carrier wave and the size of RFID tag. In some embodiments, the wireless communication device 104 may be an active RF transponder capable of storing and transmitting data to a remote device when interrogated, and is powered by an onboard power supply, such as a battery 120 (shown in FIG. 5B), or alternatively, is powered by the electrical current passing through the secondary fuse link 20 (shown in FIG. 1). In such embodiments, the operating range of communication is significantly greater than that of a passive RF transmitter, and may be of about hundreds of meters. In some embodiments, the wireless communication device 104 may be a semi-passive RF tag, which has a power source similar to that of an active RF tag, but responds to a remote device similar to a passive RF tag. In such embodiments, the operating range of communication is similar to that of a passive RF tag. The operating range may also be affected by environmental conditions (i.e., presence of water, metal). Appropriate power supplies may be utilized to meet desired specifications for a particular application and will also be apparent to those of ordinary skill in the art and are considered to be within the scope of the present invention.

In some embodiments, the modular fuseholder 100 may further include an indicating assembly 122 for local fuse state indication by visual observation. The indicating assembly 122 may include an indicating element 26 that changes appearance when the fuse element of fuse 10 opens and breaks the electrical connection through fuse 10. In some embodiments, the indicating assembly 122 may include a light-emitting diode (LED) that provides indication of an opened fuse. For example, the LED may not be illuminated when fuse 10 is in an unopened or operative, current carrying state for normal operation, and the LED may be illuminated when the monitored fuse opens to interrupt or break the current path and the electrical connection through fuse 10. In an alternative embodiment, this indication may be reversed such that the LED is lit when fuse 10 is unopened and is not lit when fuse 10 is opened. It is contemplated that other types of indicating elements may alternatively be provided to identify open fuse events. Suitable examples of alternative indicating elements include, but are not limited to, mechanical indicators having flags or pins that are extended in response to open fuses, electrical indicators having one or more light emitting elements, and indicators exhibiting color changes in response to open fuse events, such as combustible indicators and indicators having temperature responsive materials and chemically activated color changes. In any event, by virtue of an indicating assembly 122, the user may quickly ascertain whether or not any of the fuses have opened and need replacement. Thus, in some embodiments, the modular fuseholders of the present invention may also provide local fuse state indication via visual observation.

Referring to FIGS. 6A-6B, a modular indicating fuseholder 200 according to certain exemplary embodiments of the present invention similar to modular fuseholder 100 is shown. However, rather than being powered by battery 120 (shown in FIG. 5B), modular fuse holder 200 is powered by 24V DC wiring 202. Additionally, the position of the wireless communication device 104 and the size of the main body 106 differ from modular fuseholder 100. Modular fuseholder 200 also includes optical isolators 204 to interface the 600V AC circuitry of fuse 10 from the 24V DC circuitry of the circuit board assembly. Optical isolators 204 latch when a voltage differential appears across fuse 10 and sends a signal to the wireless communication device 104, which in turn sends a signal to a remote device (not shown). A power switch (not shown) or other means of resetting the optical isolators 204 may be included in the modular fuseholder 200. Diodes (not shown) also may be included in the circuit board assembly to protect input of the optical isolators 204 from stray signals or voltages. While open fuse events are detected with optical isolators 204 in certain embodiments, one of skill in the art will recognize that other detecting elements and components could be utilized with similar effect in other embodiments, and such detecting elements may monitor and respond to sensed or detected current, voltage, temperature and other operating conditions to detect open fuses. Numerous sensing and detecting elements are known that would be suitable for the indication module as described, including but not limited to current transformers, Rogowski coils, inductors, and the like as those in the art will appreciate.

The modular fuseholders of the present invention may therefore communicate, in addition to the opened or unopened state of the fuse, other information of interest regarding the fused system. For instance, improperly installed or malfunctioning fuses, as well as problems with the electrical system associated with the fuse, may result in the detecting element sensing that the fuse 10 is inoperable and transmitting such a signal to a remote device. Furthermore, fuse state indication of modular fuseholders of the present invention is implemented electronically and avoids degradation issues associated with visual indicators from the passage of time, and may be implemented in a cost effective manner.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Having described some exemplary embodiments of the present invention, it is believed that the programming of the system components to achieve desired outputs for monitoring the status of the fuses and the associated fuse system is within the purview of those in the art. While numerous changes may be made by those skilled in the art, such changes are encompassed within the spirit of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. The terms in the claims have their plain, ordinary meaning unless otherwise explicitly and clearly defined by the patentee.

What is claimed is:

1. A modular fuseholder comprising:
a main body including a fuse-receiving receptacle configured to substantially enclose a fuse within the main body;
a monitoring circuit configured in parallel across terminal elements of the fuse for monitoring at least one operational state of the fuse; and
a communication device connected to the monitoring circuit, wherein the communication device is configured to transmit a wireless signal to a remote device for indicating the at least one operational state of the fuse.

2. The modular fuseholder of claim 1, wherein the main body further comprises a pivotally mounted drawer coupled to an outer surface of the main body.

3. The modular fuseholder of claim 2, wherein at least a portion of the communication device is positioned within the drawer.

4. The modular fuseholder of claim 1, wherein the fuse-receiving receptacle is configured to receive a cylindrical fuse.

5. The modular fuseholder of claim 1, wherein the communication device further comprises a processor, a memory, or both.

6. The modular fuseholder of claim 1, wherein the communication device is powered by a battery.

7. The modular fuseholder of claim 1, wherein the communication device is configured to transmit a radio frequency signal.

8. The modular fuseholder of claim 7, wherein the communication device comprises a radio frequency transponder.

9. The modular fuseholder of claim 7, wherein the communication device comprises a radio frequency transmitter.

10. The modular fuseholder of claim 1, further comprising optical isolators, wherein the monitoring circuit latches the optical isolators when a fuse element of the fuse opens and breaks an electrical connection through the fuse, and transmits a wireless signal to a remote device.

11. The modular fuseholder of claim 1, further comprising an indicating assembly configured to provide visual indication of an operative state of the fuse when the fuse is received in fuse-receiving receptacle, wherein the indicating assembly includes an indicating element that changes appearance when a fuse element of the fuse opens and breaks an electrical connection through the fuse.

12. A modular fuseholder system comprising:
a fuse; and
a fuseholder comprising:
a main body including a fuse-receiving receptacle configured to substantially enclose the fuse within the main body;
a monitoring circuit configured in parallel across terminal elements of the fuse for monitoring at least one operational state of the fuse; and
a communication device connected to the monitoring circuit, wherein the communication device is configured to transmit a wireless signal to a remote device for indicating the at least one operational state of the fuse.

13. The modular fuseholder system of claim 12, wherein the fuse is a cylindrical fuse.

14. The modular fuseholder system of claim 12, wherein the communication device further comprises a processor, a memory, or both.

15. The modular fuseholder system of claim 12, wherein the communication device is configured to transmit a radio frequency signal.

16. The modular fuseholder system of claim 12, further comprising optical isolators, wherein the monitoring circuit latches the optical isolators when a fuse element of the fuse opens and breaks an electrical connection through the fuse, and transmits a wireless signal to a remote device.

17. The modular fuseholder system of claim 12, further comprising an indicating assembly configured to provide visual indication of an operative state of the fuse when the fuse is received in fuse-receiving receptacle, wherein the indicating assembly includes an indicating element that changes appearance when a fuse element of the fuse opens and breaks an electrical connection through the fuse.

18. A modular fuseholder comprising:
a main body including a fuse-receiving receptacle configured to substantially enclose a fuse within the main body;
a detecting means connected to the fuse and configured to detect at least one operational state of the fuse; and
a signal transmitting means connected to the detecting means, wherein the signal transmitting means is configured to transmit a wireless signal to a remote device for indicating the at least one operational state of the fuse.

19. The modular fuseholder of claim 18, wherein the detecting means is a current sensor, a voltage sensor, or a temperature sensor.

20. The modular fuseholder of claim 18, wherein the signal transmitting means is configured to transmit a radio frequency signal.

21. The modular fuseholder of claim 18, further comprising an indicating assembly configured to provide visual indication of an operative state of the fuse when the fuse is received in fuse-receiving receptacle, wherein the indicating assembly includes an indicating element that changes appearance when a fuse element of the fuse opens and breaks an electrical connection through the fuse.
